(19) United States
(12) Patent Application Publication
(10) Pub. No.: US 2017/0309422 A1
(43) Pub. Date: Oct. 26, 2017

(54) LONGITUDINAL SWITCH FOR ELECTRIC CONTACT LOCKING AND POSITION CHANGING SYSTEM

(71) Applicant: RIOTRAFO LTDA, Sao Jose do Rio Pardo (BR)

(72) Inventor: Laercio Aparecido Machado, Sao Jose do Rio Pardo (BR)

(21) Appl. No.: 15/532,084

(22) PCT Filed: Jun. 18, 2015
(86) PCT No.: PCT/IB2015/054596

§ 371 Date: May 31, 2017

(30) Foreign Application Priority Data
Jun. 12, 2015 (BR) BR1020150139519

(51) Int. Cl. H01H 19/635; H01H 3/40; H01H 1/06; H01H 9/02; H01H 3/02

(52) U.S. Cl. CPC H01H 19/635; H01H 9/02; H01H 3/02; H01H 3/40; H01H 1/06; H01H 2009/0292; H01H 2205/002; H01H 2235/01

(57) ABSTRACT

A longitudinal switch for an electric contact locking and position changing system was designed to position securely the movable switch elements (7), which are urged by springs (5) and a rack (1) and toothed gear (8) mechanism for moving a vertical shaft (9), acting upon fixed elements (contacts) (16) of an electrically insulating rail surface (15). Positions are changed by turning a control button (39) and the toothed gear (8), causing the vertical shaft (9) to rotate, thus moving the rack (1) and causing the movable elements (7) to slide on the semicircular surface (17) of the fixed elements (16), overcoming the force of the springs (5) and compressing them. Once the gap between the fixed elements (16) is located, the springs (5) push back, keeping the movable elements (7) locked and ensuring the effective electric contact with the electric current passing through these points of contact.

### BACKGROUND

The descriptive report hereof refers to a patent of invention request for a set that provides an electrical contract closing system, which is applied in a switch on distribution-type transducers. The system is operated from a couple of mobile elements placed in an adjacent form between them, working separately, through a ring gear attached to a spinning vertical-axis sprocket and a selector, sliding such mobile elements and locking them with springs against fixed elements (contacts) in order to ensure an effective and safe contact closing.

### STATE OF THE ART

As it is known, a change-over switch works on switching or changing between a range of positions for the electrical contact, which is carried out by a mechanical operation from a selector or button. This class of devices or electrical switches, in a general way, comprises mobile elements mechanically displaceable between several pre-selected positions to short-circuit fixed elements (contacts). The Brazilian patent document PI 9902210-9 hereof, described as an example, operates with opening springs, which separate the contacts, then discontinuing the power circuit current, as the opening springs (that store energy) surpass mechanical and magnetic power through a cammed-ratchet device and manual lever to release the power current.

There is a problem in this kind of device, which is the assurance in always having a good electrical contact between the fixed and mobile elements, so the current flows constantly, uninterruptedly, and without electric resistance between two or more electrical contact points. Anyhow, the common change-over switch presents a risk of placing the mobile elements in a position that would be kept close to only one of the fixed elements by turning the selector, then not setting a safe contact to keep the circuit closed.

### PATENT OBJECTIVE

This is the purpose of the switch herein, object of this patent request, which consists of a set that provides a safe positioning through mobile elements (spheres, rings, washers, rollers etc.), driven by springs that change positions in a safe way by a racket device, and it is able to offset any geometrical deformation, ensuring the electrical contact resulting from fixed elements contacts that are assembled in an electrically isolated surface. After turning the selector, the rotation of a vertical axis connected to the racket gear is transferred. Due to its actuation, the mobile elements are displaced and pressed by their corresponding separate springs, going through semi-circular heads (duly avoiding positioning flaws because of its shape) of the fixed elements (contacts), and after surpassing the power of such springs, the system is kept on the desired position, ensuring the electrical current flow through contact points.

### BRIEF DESCRIPTION OF THE DRAWINGS

As it is briefly explained about the switch and its systems, it is better detailed by the drawings attached, in which we see:

FIG. 1—Perspective view of all set components. In such view we see the racket with its receptor pin terminal on the mobile elements springs. An electrically-isolated surface rail is aligned over the racket rails, equipped with fixed elements (semi-circular head contacts), as in its end across the racket there is a vertical axis with coupling end and screwed holes attached to its sprocket, which will be closed and enveloped by lower, upper and main brackets. Main bracket threaded nozzle is placed externally to the distribution-type transducer cowl to receive an outer position display with numbered flange and screw. We can see a selector and upper cover, in addition to a locking screw, above the nut;

FIG. 2—shows the mobile racket attached to the vertical axis gear, with its threaded-hole end. In det. A, it shows the railed terminal, as in det. B, we can see the mobile elements (rollers, spheres, rings, washers etc.);

FIG. 3—shows the lower bracket aligned to the racket sprocket;

FIG. 4—shows the lower bracket with is sprocket coupled, as the racket rails are aligned to the isolated surface rails. In det. A, it shows the rails having the fixed elements (contacts) coupled, and in det. B it shows such elements have a semi-circular head;

FIG. 5—we can see the isolate surface has been inserted, and it displays, from one side, the fixed elements (contacts) and the semi-circular heads on the other side;

FIG. 6—shows the upper bracket aligned to the vertical axis. The sealing rings and main cover with ring stopper placed over its threaded nozzle are aligned on the upper bracket.

FIG. 7—shows the upper bracket mounted with its main cover, both aligned to the vertical axis;

FIG. 8—shows lower and upper brackets (the one which is assembled with the main bracket), then closing the racket sprocket;

FIG. 9—shows the switch set (assembled up until then) is placed internally to the distribution-type transducer cowl. The threaded nozzle goes through a hole opened prior in the cowl to have the components placed externally to the transducer;

FIG. 10—shows the position display has been inserted through its threaded nozzle and its numbered flange has been set, as well as the nut itself;

FIG. 11—shows the selector is aligned to the vertical axis end; FIG. 12—it shows the selector has been attached and fixed elements (contacts) have the electric wires;

FIG. 13—shows the selector being turned;

FIG. 14—shows that mobile elements go through fixed elements (contacts) after turning the selector, in a sequence presented in details A, B and C;

FIG. 15—shows the selected point has been found between fixed elements to close the electrical circuit while the mobile one keeps itself locked due to the spring;

FIG. 16—Upper view according to prior figure and the side view in detail A;

FIG. 17—shows the racket in a perspective view from semi-circular heads of fixed elements (contacts), in addition to the selector locking screw alignment. In details A and B, we can see the locking screw insertion;

FIG. 18—shows the cover being coupled to the positioning display to receive a connection strip, shown in detail A;

FIG. 19—view according to previous figure. In detail A, as well as detail B, it shows the connection strip has been attached;

Picture 20—shows the cover and selector have been locked by a locker for a full-lock restriction. In detail A it shows the enumeration of numbered flange and cover, as they match themselves and can be seen from the position view display;

Picture 21—shows the cover and selector have been locked by a lead seal for a full-lock restriction.

### DESCRIPTION OF THE EXEMPLARY EMBODIMENTS

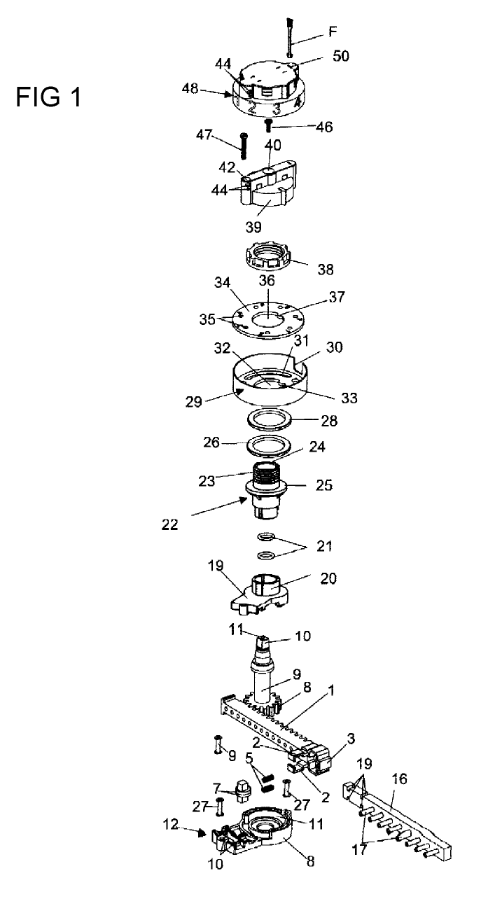

In compliance to the attached drawings, the object of the patent request hereof, consists of a switch whose components are shown entirely in FIG. 1. The switch sequential assembly is shown on figures from 2 to 12.

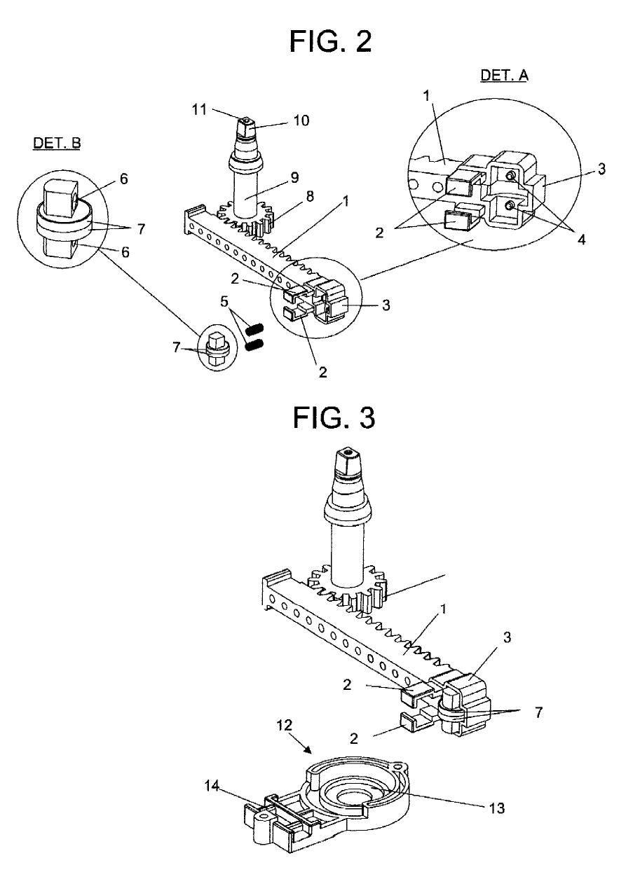

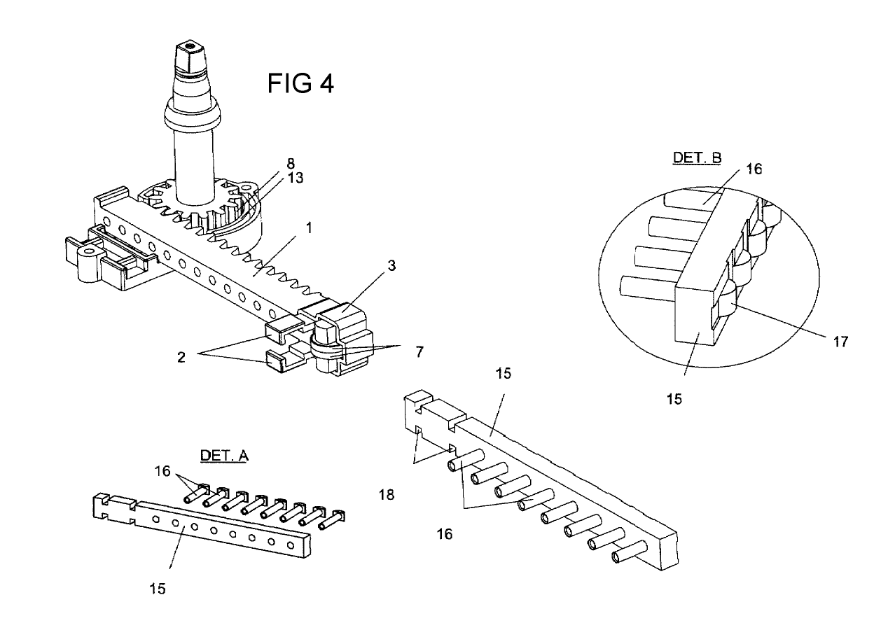

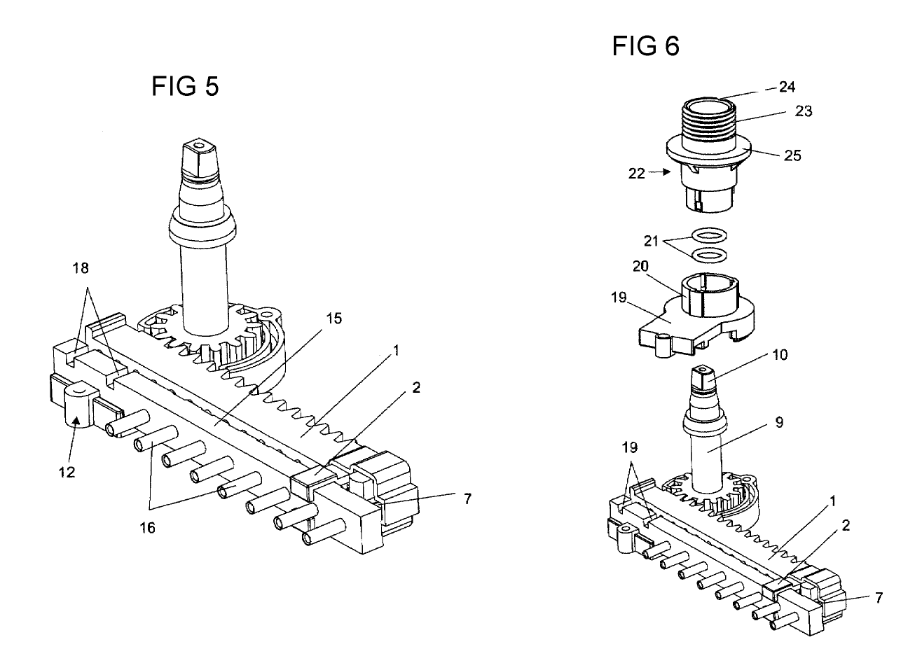

As shown in FIG. 2, a mobile racket (1) has rails (2) of a terminal (3) with a couple of inner coupling pins (4) in one of its ends, depicted in detail A, alongside the position of a couple of springs (5) pressed over conduits (6) of a corresponding pair of mobile elements (7) (which may be spheres, rollers etc.), shown at detail B. On the mobile racket (1) opposite end, it attaches a sprocket (8) that extends a vertical axis (9) with a threaded hole (11) end (10). As described in FIG. 3, mobile elements (7) have been attached, along with the springs (5) on the inner coupling pins (4) of the racket (1) terminal (3) inner part, as its sprocket (8) is aligned to a lower bracket (12) equipped with a cradle (13) and coupling ridges (14). As shown in FIG. 4, the sprocket (8) has been set on the cradle (13) with the racket (1), which presents the rails (2) of its terminal (3) aligned to an isolated surface rail (15) that receives the coupling of fixed elements (contacts) (16), as depicted in det. A. As shown in det. B, such fixed elements (16) have semi-circular heads (17). The isolated surface rail (15) have notches (18) that slide along with the racket (1) from the rails (2), as it gets fixed to the coupling ridges (14) of the lower bracket (12) cradle (13), as shown in FIG. 5. In the vertical axis (9), there is an alignment of an upper bracket (19) with a coupling frame (20) in addition to sealing rings (21) and the main bracket (22) with threaded nozzle (23) with an outer conduit (24) and ring stopper (25), as in FIG. 6.

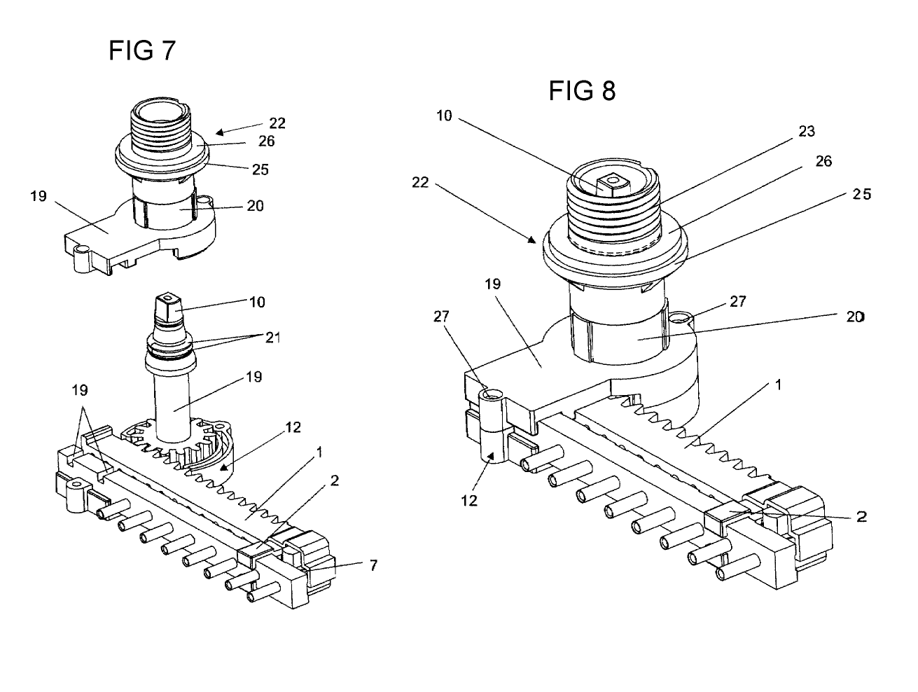

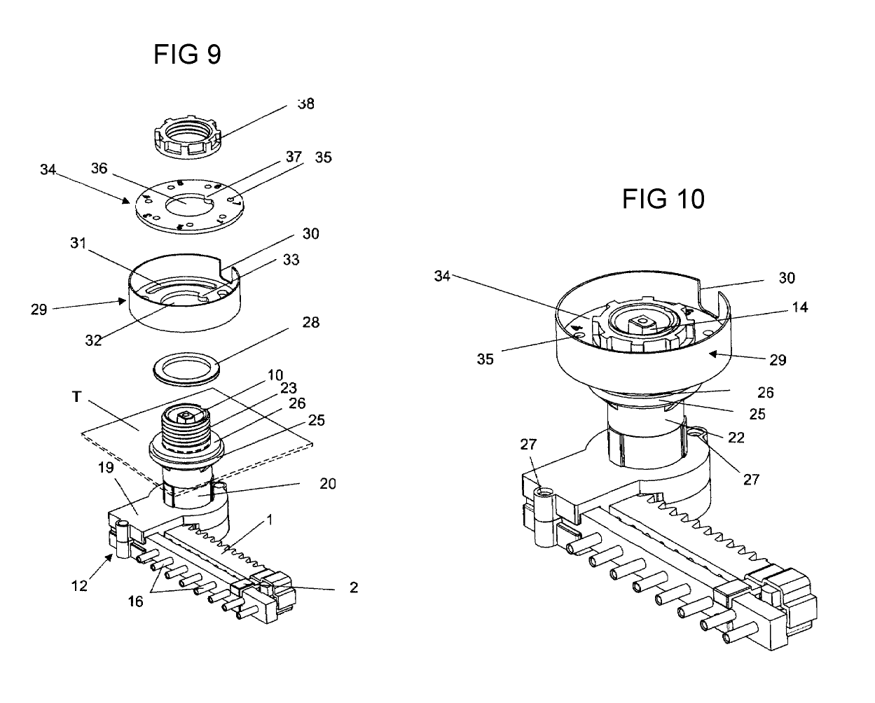

As shown in FIG. 7, the main bracket (22) supports a spacer (26) in its ring stopper (25) and it is attached to the upper bracket (19) coupling frame (20), as both are inserted in the vertical axis (9), enveloping it after they are assembled. Suck locking is carried out through rivets (27) that fix the lower bracket (12) with the upper bracket (19) and main bracket (22) assembled, further closing the sprocket (8) end of the racket (1), as shown in FIG. 8. In this situation, as shown in FIG. 9, the set of the assembled switch is inserted to the distribution-type transducer (T) and it is opened in its cowl from the hole opened previously, exposing the threaded nozzle (23). A second spacer (28) is inserted in this distribution-type transducer (T) through such threaded nozzle (23), which further aligns a positioning display (29) trimmed by window (30) on its circular wall, as it is bottom-hollowed by radial elongated notches (31), which are distributed around a center hole (32), whose border point may fit a guiding cog (33). This positioning display (29) may have aligned a numbered flange (34) along with radial holes (35) and a center hole (36), then inserting a guiding cog (37) in its border, which is aligned to the guiding cog (33) and a nut (38).

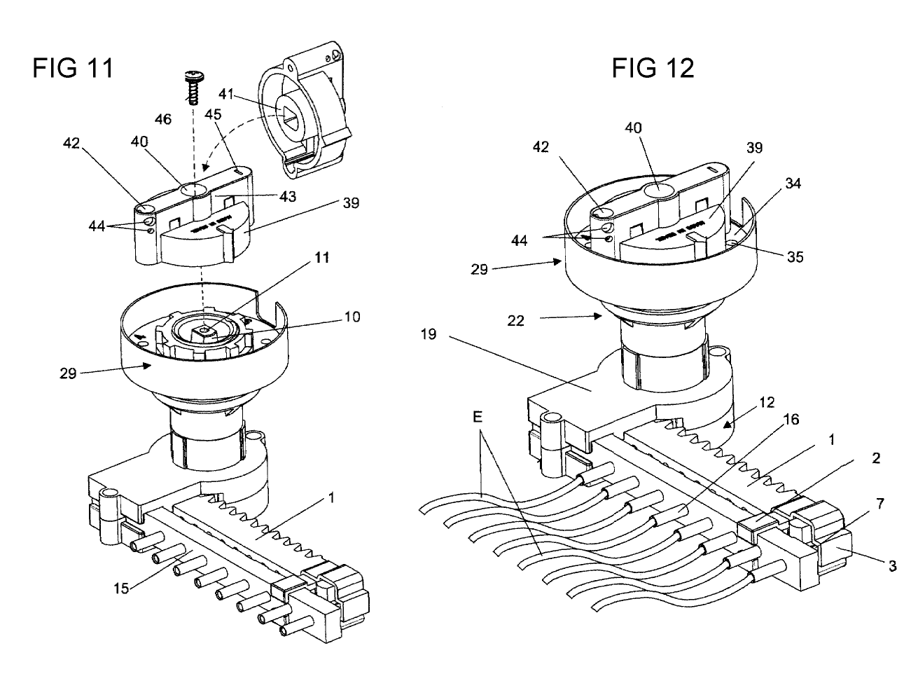

Thus, as shown in FIG. 10, the positioning display (29) is set over the spacer (28) that slides through its guiding cog (33) in the threaded nozzle (23) conduit (24), by which also slides the numbered flange (34) through, equally over its guiding cog (37) that, on the other hand, is set on said positioning display (29), followed by nut (38) locking, which is tightened on the threaded nozzle (23). As shown in FIG. 11, a selector (39) is aligned at a threaded nozzle (23) that is hollowed by a center hole (40) with female terminal (41), in addition to a vertical hole (42) in one side of its handle (43), fulfilled with two different-diameter horizontal holes. The selector (39) receives a notch (45) on its handle (43) opposite side, as a locking screw (46) is aligned in the center hole (40). As shown in FIG. 12, after coupling its female terminal (41), selector (39) receives the locking screw (46) that is screwed to the threaded hole (11) on the end (10), locking it at the vertical axis (9), followed by the electrical cables connection (E) from the distribution-type transducer (T).

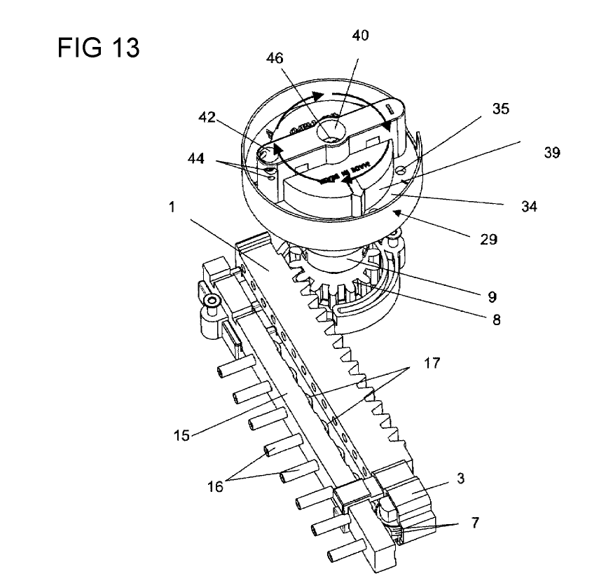

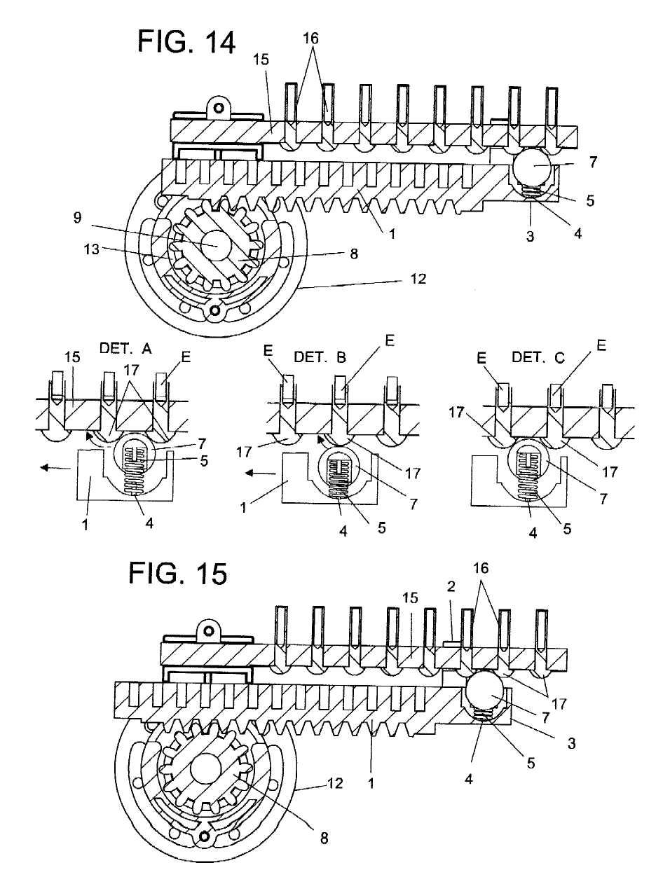

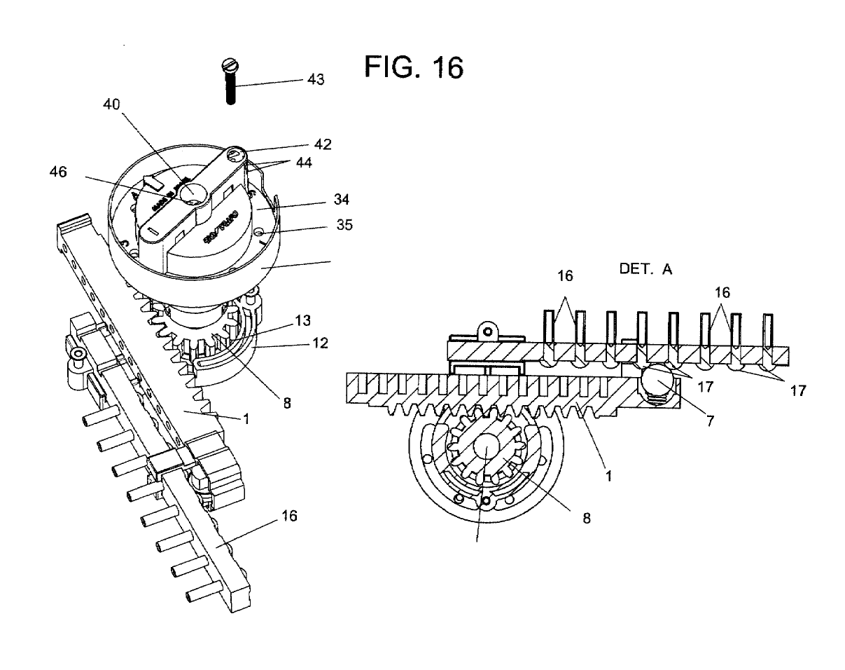

The following figures, from 13 to 21, refer to the said switch operation. After turning the selector (39) as shown in FIG. 13, the vertical axis (9) is also turned along with the sprocket (8) that carries the racket (1), making that mobile elements (7) slide over semi-circular heads (17) of the fixed elements (16), as depicted in details A, B and C of FIG. 14. After covering semi-circular surfaces (17), the mobile elements (7) surpass spring power (5), compressing them until they find a gap between fixed elements (16). In such condition, the springs (5) return themselves and keep mobile elements (7) positioned in these spaces between the semi-circular heads (17) of the fixed elements (16), in a closed-circuit position, i.e., carrying out the electrical contact as shown in FIGS. 15 and 16 by means of detail A. Due to the fact the heads (17) are semi-circular, mobile elements (7) shall not position over a single fixed element (16), keeping them always on the electrical contact setting space. As pairs assembled separately themselves, the wear in one of the fixed elements (16) during racket (1) slide becomes offset by other fixed element (16), ensuring a better durability to the system.

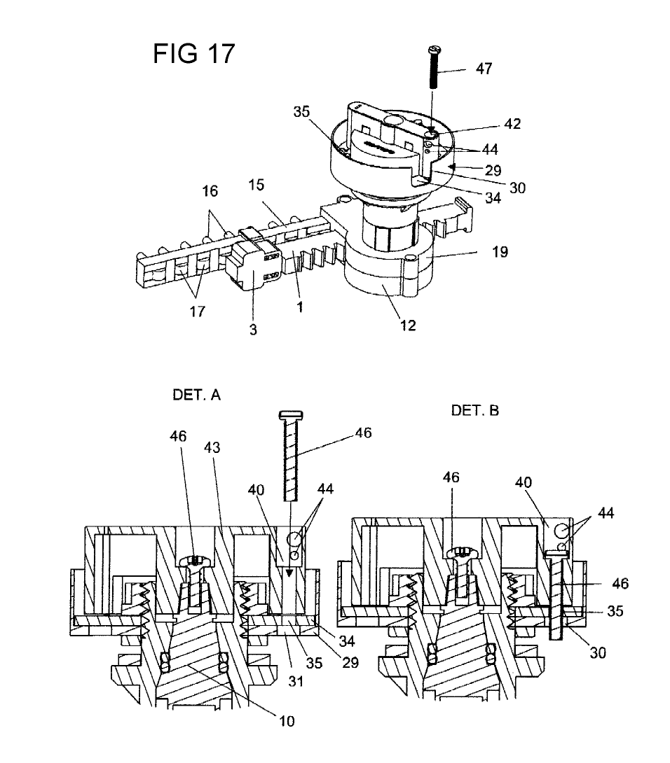

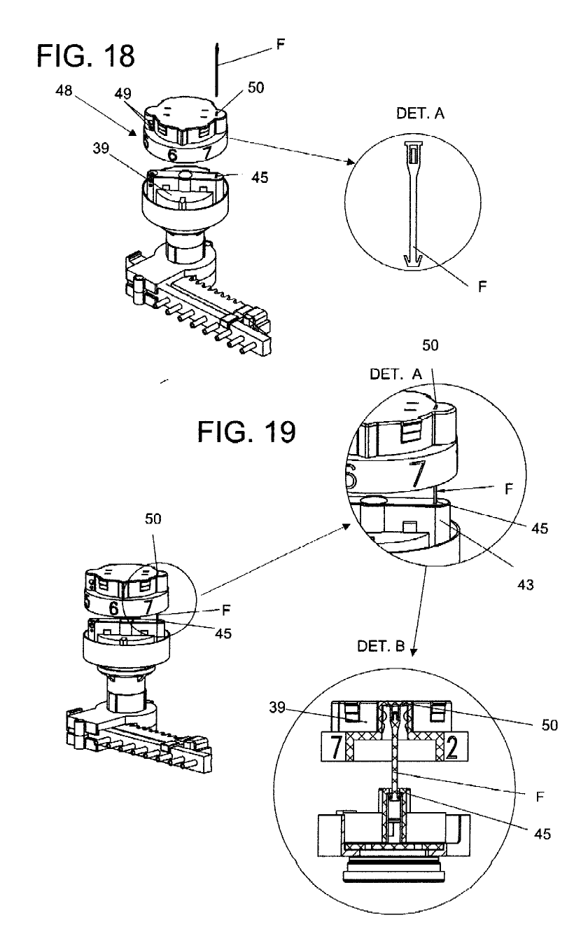

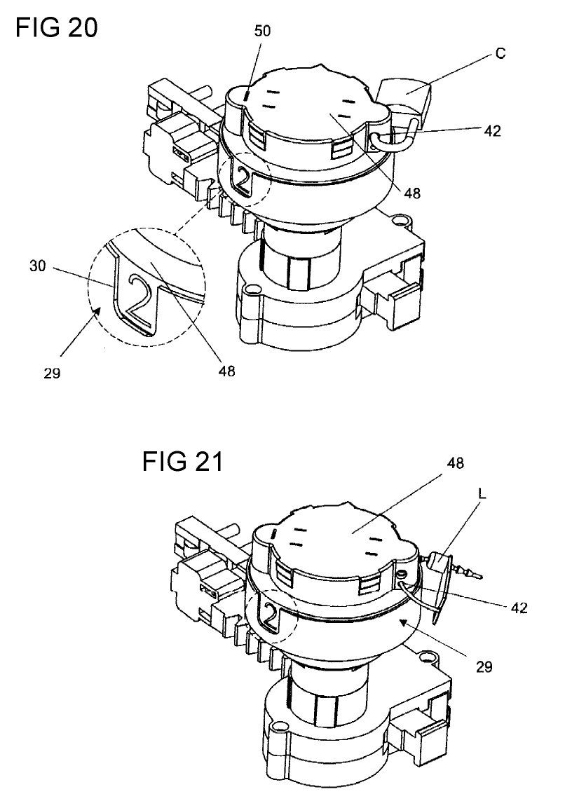

Thus, as shown in FIG. 17, and the switch is set appropriately by the selector (39), inserts a second screw (47) by its handle (43) vertical hole (42), in order the screwed structure exceeds the numbered flange (32) holes (35) and reach the elongated notches (31) of the outer position display (29), further locking the selector (39) at the desired position, as shown in details A and B. Then, a cover (48) with side holes (49) and side notch (50) is inserted. A strip (F) goes through the notches (50) and (45) of the cover (48) and selector (39) respectively, as shown in pictures 18 and 19 and details A, A and B, then setting a connection between them. As we can see in FIG. 20 and such detail A, the cover (48) numbering matches with the numbered flange (32) enumeration in order to view the switch locking position through the positioning display (29) window (30). At last, as shown in pictures 20 and 21, a locker (C) or lead seal (L) is inserted between the cover (48) holes (49) and selector (39) holes (44), which identify when the switch is altered or handled inappropriately in case they are broken.

1.—LONGITUDINAL SWITCH, characterized by a mobile racket (1) with rails (2) of a terminal (3) with a couple of inner coupling pins (4), a couple of springs (5) pressed over conduits (6) of a corresponding pair of mobile elements (7) (assembled separately themselves), and said racket (1) receives, at is opposite end, a sprocket (8) that extends the vertical axis (9) with a threaded hole (11) end (10), as said sprocket (8), which is set in a lower bracket (12) with cradle (13) and coupling ridges (14), whereas an isolated surface rail (15) is inserted through the rails (2) with fixed elements (contacts) (16) assembled previously, equipped with semi-circular heads (17), as that rail (15) is locked onto the racket (1) by means of notches (18) coupled to such coupling ridges (14) of the lower bracket (12), as the vertical axis (9) receives an upper bracket (19) with coupling frame (20) and sealing rings (21), assembling a main bracket (22) with threaded nozzle (23), equipped with an outer conduit (24), ring stopper (25) and spacer receiver (26).

2.—LONGITUDINAL SWITCH, according to claim 1, after being assembled, the upper bracket (19) with main bracket (22), is characterized_due to both being inserted in a way to envelop the vertical axis (9), followed by locking said upper bracket (19), then closing the racket (1) sprocket (8) gear, exposing the threaded nozzle (23) by a hole opened previously on the distribution-type transducer (T) cowl;

3.—LONGITUDINAL SWITCH, according to claim 1 characterized by setting over the outer cowl surface of distribution-type transducer (T), from a second spacer (28), a positioning display (29) receptor hollowed by the window (30) in its circular wall and bottom-hollowed by radial elongated notches (31) presented around a center hole (32), whose point in its border is inserted to a sliding guiding cog (33) through the conduit (24) of the threaded nozzle (23), by which the center hole (36) guiding cog (37) also slides into, combining to radial holes (35) from a numbered flange (34) bottom, which, in turn, is set over said positioning display (29), followed by its locking through a nut (38) that is tightened in the threaded nozzle (23), as the latter then receives a female terminal (41) of a selector (39) hollowed by its center hole (40), in addition to a vertical hole (44) of distinct diameters, whereas said selector (39) still has a notch (45) on the opposite side of this handle (43).

4.—SWITCH FOR POSITION EXCHANGE AND LOCKING SYSTEM, according to claim 1, after rotating the selector (39), is characterized by turning the vertical axis (9) and sprocket (8), carrying the racket (1) to slide mobile elements (7) by semi-circular heads (17) of fixed elements (16), then surpassing springs power (5) and compressing them until they find enough room between said fixed elements (16), whereas after such springs (5) return, the mobile elements (7) are locked in these spaces, in a closed-circuit position, followed by the insertion of the selector (39) locking screw (47) through the vertical hole (42), of a locking screw (47), reaching for the numbered flange (32) holes (35) and reaching the elongated notches (31) of the positioning display (29), provided that a locker (C) or lead seal (L) is inserted between cover (48) holes (49) and selector (39) holes (44).

5.—SWITCH FOR POSITION EXCHANGE AND LOCKING SYSTEM, according to claim 1, characterized by semi-circular heads (17) geometry that prevent mobile elements (7) during shift from flowing over a single fixed element (16).

6.—SWITCH FOR POSITION EXCHANGE AND LOCKING SYSTEM, according to claim 1, characterized by cover (48) numbering to match the enumeration of the numbered flange (32), then viewing the switch locking position through the positioning display (29) window (30).
